(19) United States
(12) Patent Application Publication
(10) Pub. No.: US 2008/0291452 A1
(43) Pub. Date: Nov. 27, 2008

(54) Optical Switching Device

(75) Inventors: Bernard Dam, Den Haag (NL); Ronald Pierre Griessen, Kortenhoef (NL); Wiebke Lohstroh, Frankfurt (DE); Mathieu Raymond Henri Pasturel, Rennes (FR); Marinus Johannes Slaman, Waddinxveen (NL)

Correspondence Address: YOUNG & THOMPSON, 209 Madison Street, Suite 500, ALEXANDRIA, VA, 22314, US

(73) Assignee: ADVANCED CHEMICAL TECHNOLOGIES FOR SUSTAINABILITY, DEN HAAG (NL)

(21) Appl. No.: 12/091,864

(22) PCT Filed: Oct. 27, 2006
(86) PCT No.: PCT/NL2006/050268

§ 371 Date: Jul. 7, 2008

(30) Foreign Application Priority Data
Oct. 28, 2005 (NL) 1030299

(51) Int. Cl. G01N 21/61

(52) U.S. Cl. 356/437

(57) ABSTRACT

Optical switching device comprising a substrate on which a magnesium transition metal layer such as a magnesium nickel metal layer is provided. At supplying of hydrogen the magnesium transition metal layer is, starting from the substrate, converted to a magnesium transition metal hydride layer. This has optical properties different from the magnesium transition metal layer. The change in optical properties viewed from the transparent substrate side can change from reflective to transparent wherein a black phase is in between. To obtain and maintain this black phase is relatively critical. However, there are many applications in which such a black phase could be very useful. In order to be able to obtain a stable black phase according to the invention it is proposed to have a relatively thin magnesium metal layer for example of 50 nm at the maximum and to provide an auxiliary layer on top of the magnesium transition metal layer.

The present invention relates to a hydrogen sensor having an optical switch. With such a sensor the optical properties of an optical switching device can be monitored.

Such hydrogen sensor is known from U.S. Pat. No. 6,006,582.

As active metal a magnesium transition metal alloy is for example used. It has been found that a magnesium nickel layer being provided on a substrate and on top of which a catalyst such as palladium is provided will turn into a magnesium nickel hydride layer near the substrate when hydrogen is added to such layer. This means that although hydrogen enters the device through the catalyst the hydride phase nucleates first at the magnesium nickel layer/substrate interface. This leads to a self-organized layering of the sample. With increasing hydrogen absorption the hydride layer grows until the whole magnesium nickel layer is converted to a hydride. Such layers are also known as VAriable REflection Metal hydrides (VAREM) or metal-hydride switchable mirrors.

Depending on the conversion such a layer can have properties ranging from reflective through black to transparent. The transparent and reflective modes are relatively stable and easy to obtain and maintain. However a stable black situation in which the light entering through the substrate is absorbed, is difficult to maintain. It depends sensitively on external parameters such as temperature and H₂ gas pressure.

The different physical appearances are preferably obtained by loading with hydrogen or unloading hydrogen for example by using oxygen. Electrochemical hydrogenation/dehydrogenation can also be used. The hydrogen concentration in which the black condition is obtained is very critical.

US 2002/101413 discloses a light switching device, for use as a optical switching element, for example as a variable beam splitter, optical shutter, and for controlling the a luminance or the shape of light beam luminaries, wherein a switching film is provided with a catalyst Pd-layer on which a hydrogen ion conducting electrolyte layer is provided. On this hydrogen ion conducting electrolyte layer a hydrogen storage layer is present. With this device one actively controls the amount of hydrogen and thereby the optical state of the active layer.

US2005/0173716 A1 discloses the use of VAREM material for switching between black absorbing and metallically reflecting in the optical portion of the spectrum. This is used for a device for converting solar energy into heat energy and more particular is present between an sunlight/transmitting plate and a rear plate.

The invention aims to provide a hydrogen sensor in which the black condition is both easily obtained and on the other hand can easily be maintained.

According to the invention this is realized in that, between said active metal layer and said catalytic layer an auxiliary layer comprising a transition metal layer is provided having a thickness larger than the thickness of said active metal layer and being hydrogen permeable.

According to the invention there is no longer a “self-organized” double layer needed to provide for the large change in optical behavior. The self organized double layer is according to the invention replaced by an auxiliary layer which has been separately provided and comprises a transition metal layer. In contrast to the prior art an auxiliary layer is provided between the metal layer and the catalytic layer.

It has been found that by using an artificially provided auxiliary layer a stable black condition is obtained of the magnesium transition metal (hydride) layer. It has also been found that after unloading the hydrogen and reloading with hydrogen reproducible results are obtained which means that switching can be obtained in a reproducible way making the optical switching device suitable for all kinds of applications.

Furthermore it has been found that a better contrast can be obtained and oxidation protection is further improved.

The thickness of the transition metal layer should be such that there is no or little transmission.

The active metal layer can comprise any metal which has changing optical properties at loading or unloading with hydrogen. As example magnesium or magnesium based transition metals are mentioned. Also combination of several elemental metals can be used or metal hydrides such as yttrium hydride being in the metallic phase. Further possibilities for the active layer can be rare earths including yttrium, possibly in combination with a transition metal, magnesium and so on. Another preferred option is the use of Mg₂Ni or Mg₁₋ₓTiₓ as active layer.

According to a preferred embodiment of the invention the active layer has a thickness of 100 nm at maximum. The transition metal layer or auxiliary layer has a thickness starting from 10 nm and is preferably not more than 1 μm.

The auxiliary layer can comprise layers being positioned on top of each other and comprising a different transition metal for example titanium, nickel and/or niobium. It is also possible that different layers are stacked on each other having a different structure, as long as the layer stack allows for hydrogen diffusion and is optically reflective.

The substrate according to the invention can comprise any material such as glass.

The transition metal of the transition metal layer can comprise any transition metal known from the periodic system and in more particular titanium and/or palladium.

The same applies to the transition metal in the magnesium transition metal active layer which preferably comprises nickel.

According to an advantageous embodiment the hydrogen sensor is passive. This means that switching is only obtained by gas pressure and not to the use of electrical voltage. However, an embodiment being electrolytically switched is within the range of the subject application.

The hydrogen sensor according to the invention can be prepared by deposition of the several layers mentioned above on a substrate. This deposition can comprise sputtering such as co-sputtering of the several metals to obtain for example the magnesium transition metal layer.

It is possible that there is a distance between the optical switching device and the optical sensor which can be bridged by fiber optics. Furthermore it is possible to monitor a large number of optical switching devices with a single optical sensor.

The hydrogen sensor comprising the optical switching device can be embodied to have the optical properties reversible or non-reversible. An example for the last possibility is the use of a tag which shows exposure of an article or person in an environment in which hydrogen might be present. Such a tag can be disposable.

The invention will be further elucidated referring to embodiments shown in the drawing wherein:

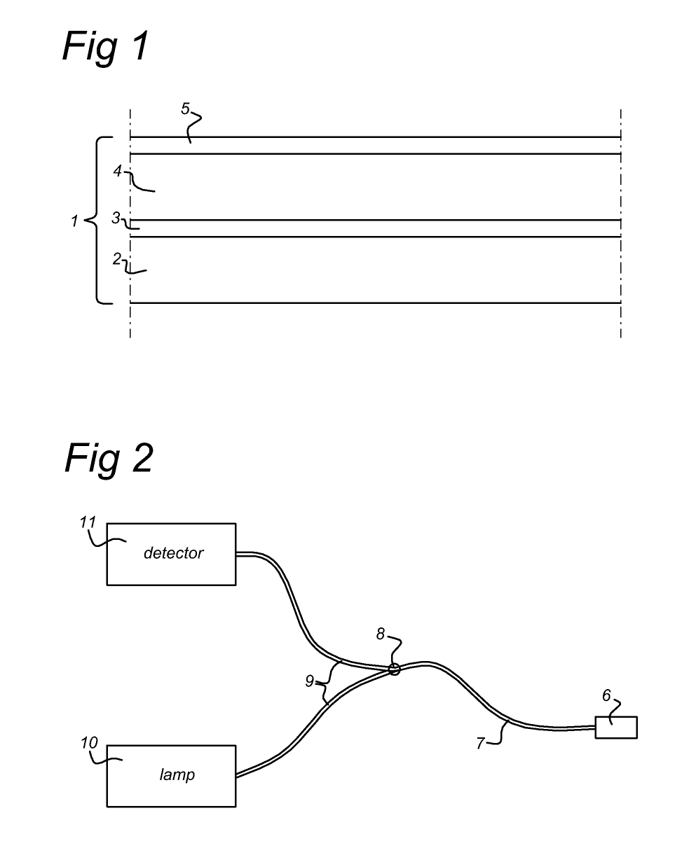

FIG. 1 schematically shows the layer structure of an optical switching device according to the invention;

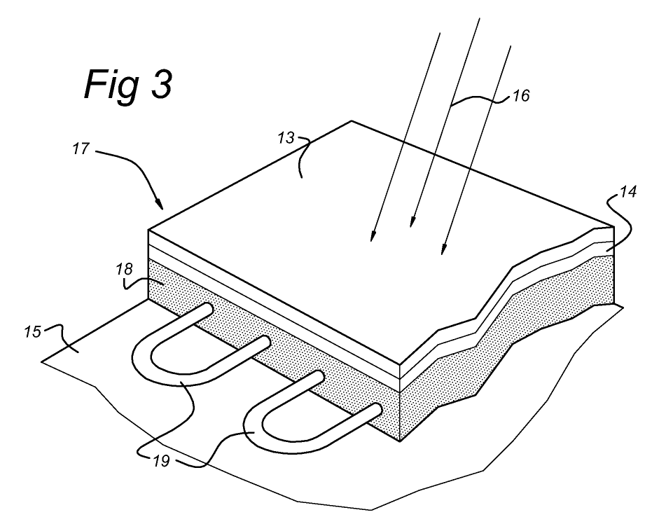

FIG. 2 schematically shows the application of the optical switching device as a hydrogen sensor; and

FIG. 3 shows the use in an energy conversion assembly.

In FIG. 1 an example for an optical switching device to be used for a hydrogen sensor according to the invention is generally referred to by 1. A substrate 2 is present which can be any material. However, preferably glass is used as is usual in optical devices. On top of the glass a 30 nm magnesium transition metal layer as active layer is provided such as an Mg₂Ni layer. On top of this active layer 3 an auxiliary layer 4 according to the invention is arranged. This is a transition metal layer such as a titanium layer or a palladium layer. The thickness thereof is from 10 nm and more preferably between 50 and 200 nm. On top of the auxiliary layer a catalyst layer 5 is provided being for example a palladium layer having a thickness of about 10 nm.

If hydrogen is added to such an optical switching device 1 the Mg₂Ni layer will convert to Mg₂NiH₄. The optical properties of this material are completely different from Mg₂Ni.

According to the invention an artificial double layer comprising the layers 3 and 4 has been synthesized. Mg₂NiH₄ is transparent while hydrogenated titanium which is for example used in layer 4 remains reflective.

During tests it revealed that the reflection observed through the layer structure in an energy range 1.25-3 eV goes from around 60% before hydrogenation to about 5% at 1.9-2 eV in the totally hydrogenated layer 3. This is a ratio of 12 in reflection. At room temperature such hydrogenation, when a 5% H₂ in Ar is used is effected in typical 10 seconds depending on the thickness of layer 4. A sensitivity of 0.3% H₂ has been observed.

In FIG. 2 the use of the optical switching device according to the invention in a hydrogen sensor according to the invention is shown. The optical switching device according to the invention is indicated with 6 which is connected through fiber optic 7, 9 (with the use of a bifurcator 8) to a detector 11. 10 is a light source (for example a lamp or a laser) to provide light to the switchable mirror 6. If only small quantities of hydrogen are present in the room in which the optical switching device is present immediately a remarkable change in reflective properties of the optical switching device occurs which is easily detected by detector 11. Detector 11 can be connected to a number of fiber optics being connected to optical switching devices in the same room or in different areas.

In FIG. 3 a further application of the invention is shown. On a schematically shown roof 15 an energy conversion assembly 17 is provided. This comprises a photovoltaic element 13, an optical switch 14 according to the invention and a fluid heater 18 such as a water heater having heating tubes 19. Depending on the conditions it is desirable that incident light as indicated by arrow 16 will or will not reach heater 18. By controlling optical switching device 14 as indicated above this can be prevented. If the optical switching is in the black condition heat will be absorbed and transferred to heater 18. If it is in the reflective mode the heat will not be absorbed and reflected back through to the photovoltaic element 13. Even without the photovoltaic device, the invention can be used solely to control the temperature of the water heater.

In the above some applications of the photovoltaic switching device according to the invention have been discussed. However it should be understood that further applications are possible both on Earth and in space. As example the use on the outer surface of a satellite is mentioned.

1-18. (canceled)

19. Hydrogen sensor comprising an optical switching device with a substrate (2), an active metal layer (3) provided on said substrate having different optical properties at loading/unloading with/of hydrogen and a catalytic layer (5), characterized in that, between said active metal layer and said catalytic layer an auxiliary layer (4) comprising a transition metal layer is provided having a thickness larger than the thickness of said active metal layer and being hydrogen permeable.

20. Hydrogen sensor according to claim 19, comprising an optical sensor (11) to monitor the state of said optical switching device.

21. Hydrogen sensor according to claim 20, wherein a fiber optic (7, 9) is coupled between said optical switching device (6) and said optical sensor (11).

22. Hydrogen sensor according to claim 19, wherein said auxiliary metal layer is a transition metal based layer.

23. Hydrogen sensor according to claim 19, wherein said active metal layer is a rare-earth based layer.

24. Hydrogen sensor according to claim 19, wherein said active metal layer is a Mg based layer.

25. Hydrogen sensor according to claim 19, comprising a black switching condition.

26. Hydrogen sensor according to claim 19, wherein said active metal layer has a thickness of 500 nm at maximum.

27. Hydrogen sensor according claim 19, wherein said substrate comprises glass.

28. Hydrogen sensor according to claim 19, wherein the metal of said catalytic metal layer comprises titanium and/or palladium and/or silver.

29. Hydrogen sensor according to claim 19, wherein said transition metal layer has a thickness of 10 nm-2 μm.

30. Hydrogen sensor according to claim 19, wherein the transition metal of the active transition metal layer comprises nickel, titanium, palladium.
